(19) United States
(12) Patent Application Publication
(10) Pub. No.: US 2025/0134749 A1
(43) Pub. Date: May 1, 2025

(54) Walker

(71) Applicant: Yudan Huang, Foshan (CN)

(72) Inventor: Yudan Huang, Foshan (CN)

(21) Appl. No.: 19/004,228

(22) Filed: Dec. 28, 2024

(51) Int. Cl. A61H 3/00

(52) U.S. Cl. CPC A61H 3/008; A61H 2003/002; A61H 2201/0161; A61H 2201/0192; A61H 2201/1638; A61H 2201/169; A61H 2203/0406

(57) ABSTRACT

The invention provides walker comprising a first and second support frame, an expansion rod, an expansion bar arranged at both ends of the first and second supports, and a mounting frame fixed to one side of the first support frame and one side of the second support frame. Walker as provided by the present invention, Through the first support frame, the second support frame, the expansion rod, the mounting frame and the rotating frame, At the time of its use, Pull on the expansion rod, Slide the expansion rod on the outer sides of the first and second support frames, Thus facilitate the user to adjust the height of the aid, To meet the use of users of different heights, Increased the adaptability of the device, And by the first and the second support side by the mounting frame and the rotating frame.

### TECHNICAL FIELD

The invention relates to the technical field of medical devices, in particular to a walking aid.

### BACKGROUND TECHNOLOGY

At present, after the finish the patients of lower limb orthopedic surgery, clinical lower limb fracture patients in rehabilitation exercise mostly use walker for postoperative exercise and restore walking, walker used for patients need function exercise, such as: orthopedic elderly, hip, knee replacement patients, in addition for other disabled people to walk balance without confidence, also can use the walker to assist its walking.

Existing walker, through the bottom roller mobile frame, convenient walker movement, moving, the user to move the body, can through the grip drive the brake line, make the brake pad into the roller brake groove, make the roller fixed, the brake pad pressure into the brake slot, rolling forward with the brake pad and brake groove contact will gradually rise, the walker movement resistance gradually increases, make the walker fixed more stable, convenient walker stable move.

However, when the walker is used, it is not convenient for the user to adjust the height of the walker, and can not adapt to the users of different heights, thus reducing the adaptability of the walker, and after the use, it is not convenient for the user to fold and store the walker, increasing the floor space.

Therefore, it is necessary to provide walker to solve the above technical problems.

### INVENTION CONTENT

The invention provides walker that solves the problem of failing height adjustment, reducing adaptability and failing folding and storage after use, and increasing the storage space.

To solve the above technical problems, walker is provided by the present invention, comprising:
First, first and second support frame;
An expansion rod each disposed at both ends of the first frame and the second frame;
Installation frame, the mounting frame is fixed to one side of the first supporting frame and a side of the second supporting frame, one end of the outer side of the mounting frame is fixed with a rotating frame, and one end of the other mounting frame is connected to the inner side of the rotating frame;
The grip is mounted on the outer sides of the first support and the second support respectively.

Preferably, one end sleeve of the outer side of the expansion rod is provided with a rubber head.

Preferably, the inner sides of the first and the second supports are fixed with connection frames.

Preferably, both one side of the first support frame and one side of the second support frame are fixed with fixed frames provided with several card interfaces.

Preferably, a positioning plate is provided on one side of the fixing frame, one side of the positioning plate is fixed with a hook, and the hook card is connected to the inner side of the card interface.

Preferably, the other side of the positioning plate is fixed with a connecting belt, and the outer side sleeve of the connecting belt is provided with a slip sleeve.

Preferably, the top of the sleeve is fixed with a sponge pad.

Compared with the related techniques, a aid provided by the invention has the following beneficial effects:

The present invention provides walker, Through the first support frame, the second support frame, the expansion rod, the mounting frame and the rotating frame, At the time of its use, Pull on the expansion rod, Slide the telescopic rod on the outer sides of the first and second support frames, Thus facilitate the user to adjust the height of the aid, To meet the use of users of different heights, Increased the adaptability of the device, And by the first and the second support side by the mounting frame and the rotating frame, Thus convenient for users when not using, Fding the walker, Rotate and fold the rotating frame so as to fold the walker three times for storage, Reduce your space footprint.

### ATTACHED FIGURE DESCRIPTION

FIG. 1 is a schematic view of the first embodiment of walker provided by the present invention;

FIG. 2 is the rubber head structure shown in FIG. 1;

FIG. 3 is a schematic view of a second embodiment of walker provided by the present invention;

FIG. 4 is the side structure of the mounting frame shown in FIG. 3;

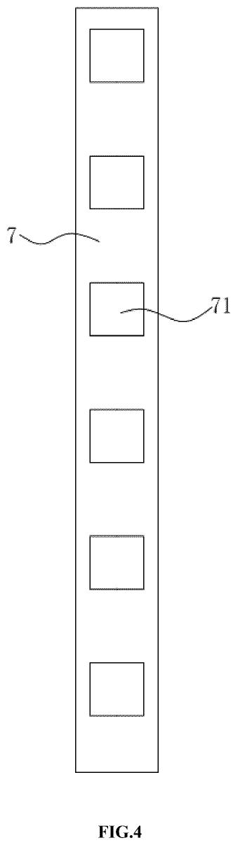

FIG. 5 is a schematic diagram of the hook structure shown in FIG. 3.

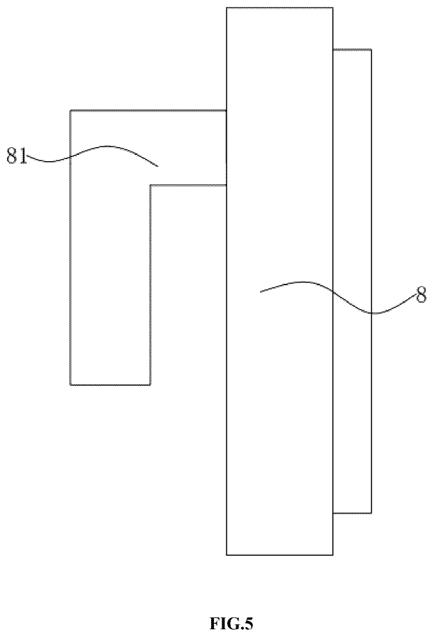

Figure mark number: 1, the first support frame, 2, the second support frame, 3, connection frame, 4, expansion rod, rubber head, 5, grip, 6, installation frame, rotating frame, 7, fixed frame, 71, card interface, 8, positioning plate, hook, 82, connection belt, 83, slip sleeve, 84, sponge pad.

### SPECIFIC IMPLEMENTATION METHODS

The present invention is further explained below in combination with the accompanying drawings and the embodiments.

### First Embodiment

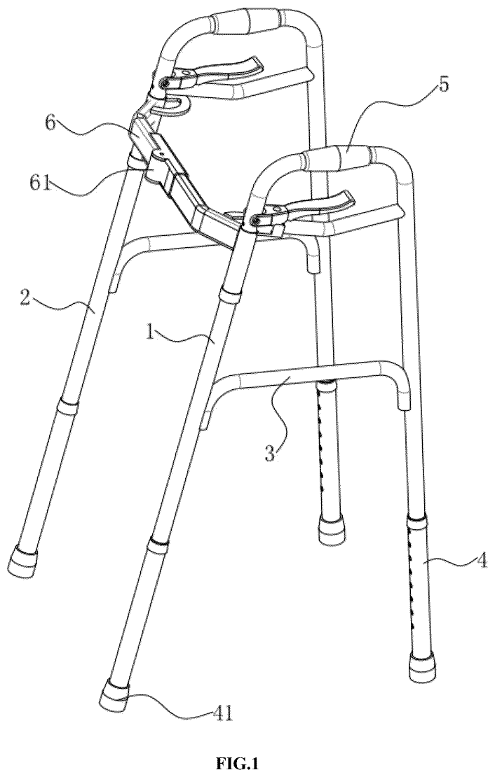

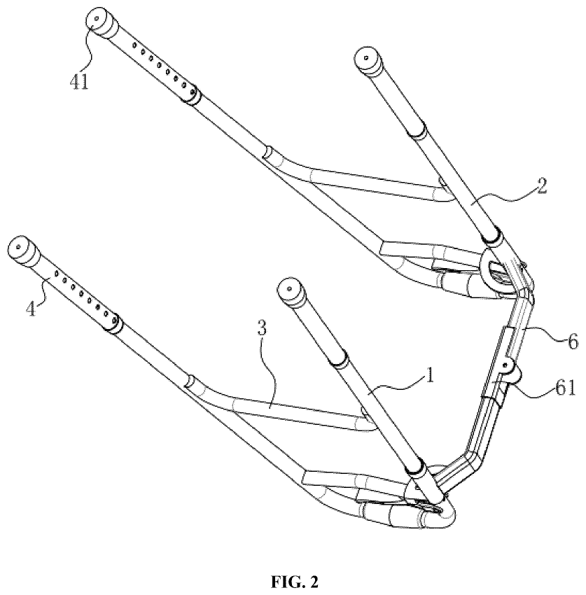

Referring to FIG. 1 and FIG. 2, FIG. 1 is a schematic diagram of the first embodiment of walker provided by the present invention; FIG. 2 is a schematic diagram of the rubber head structure shown in FIG. 1.

Walker including first support 1 and second support 2;

The expansion rod 4 is disposed at both ends of the first support frame 1 and the second support frame 2;

Installation frame 6, the mounting frame 6 is fixed to one side of the first support frame 1 and one side of the second support frame 2, one end of the outer side of the mounting frame 6 is mounted with a rotating frame 61, and one end of the mounting frame 6 is rotated and connected to the inner side of the rotating frame 61;

The grip 5 is mounted on the outer sides of the first support 1 and the second support 2 respectively.

One end sleeve of the outer side side of the telescopic rod 4 is provided with a rubber head 41.

The inner sides of the first support 1 and the second support 2 are fixed with connection connection 3.

Several positioning holes on the side of the expansion rod 4, and a mounting hole on the side of the first support 1 and the side of the second support 2, and the inner side of the installation hole spring, a positioning block is fixed at the end of the spring, through the spring to push the positioning block, so that the positioning block into the inner side of the positioning hole, so as to limit the expansion rod 4, avoid its movement, the positioning block sliding on the inner side of the installation hole, and cannot be completely by the spring out of the inner side of the mounting hole;

During the use, the user stands between the first support 1 and the second support 2, holds the grip 5 with both hands and then walks.

The working principle of walker provided by the present invention is as follows:

When the user needs to adjust the height of the walker, the user can pull the expansion rod 4 to slide the expansion rod 4 on the outer side of the first support 1 and the second support 2, thereby adjusting the height of the first and the second support 2, and after the end of use, the user can rotate the second support 2 to slide one end of the mounting frame 6 on the inner side of the rotating frame 61 to overlapping the side of the first support 1 and the second mounting frame 2, thereby folding the first support 1 and the second support 2.

Compared with the related techniques, a aid provided by the invention has the following beneficial effects:
Through structures such as the first support frame 1, the second support frame 2, the expansion rod 4, the mounting and the mounting frame 6 and the rotating frame 61, At the time of its use, Pull on the expansion rod 4, Slide the expansion rod 4 on the outer sides of the first support frame 1 and the second support frame 2, Thus facilitate the user to adjust the height of the aid, To meet the use of users of different heights, Increased the adaptability of the device, By connecting the first and second support frames 2 through the mounting frame 6 and the rotation frame 61, Thus convenient for users when not using, Fding the walker, Rotate and fold the rotating frame 6 so as to fold the walker three times for storage, Reduce your space footprint.

### Second Embodiment

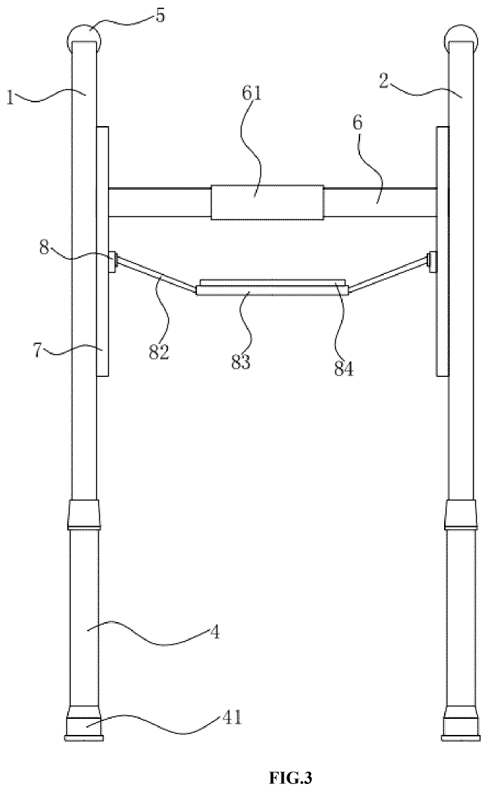

With reference to FIGS. 3,4, and 5, based on the first embodiment of the present application, the second embodiment of the present application proposes another aid. The second embodiment is only a preferred mode of the first embodiment, and the implementation of the second embodiment will not affect the separate implementation of the first embodiment.

Specifically, walker provided by the second embodiment of this application differs in that a side of the first support frame 1 and a side of the second support frame 2 are fixed with a fixing frame 7, a side of the fixing frame 7 having a number of card interfaces 41.

A positioning plate 8 is provided on one side of the fixing frame 7 with a hook 81 with the hook 81 attached to the inner side of the card interface 71.

The other side of the positioning plate 8 is fixed with a connection belt 82, and the outer side sleeve of the connecting belt 82 is provided with a sliding sleeve 83.

The slide sleeve 83 is fixed at the top with a sponge pad 84.

Several card interfaces 71 are provided on one side of the two fixed frames 7, so that the user moves the positioning plate 8 to the inner sides of the different card interface 71, thereby adjusting the height of the connection belt 82, thus allowing the user to use according to different heights and increasing the applicability of the device.

The working principle of walker provided by the present invention is as follows:
After the user walker walks for a period of time, the user may move the positioning plate 8 of the end of the connecting belt 82 to one side of the fixing frame 7 and attach the hook 81 into the inner side of the card interface 71 to secure one end of the connecting belt 82, after which the user can move the slide sleeve 82 to the middle of the connecting belt 82, after which the user sits on the sponge pad 84.

Compared with the related techniques, a aid provided by the invention has the following beneficial effects:
With the fixing frame 7, the card interface 71, the positioning plate 8, the hook 81, the hook 81, the connecting belt 82, the slip sleeve 83 and the sponge pad 84, the user can sit on the sponge pad 84, so that the user can rest after walking and facilitate the user to use.

The above are only embodiments of the invention and do not thus limit the scope of the invention. All the equivalent structure or equivalent process transformations made by the description of the invention and the contents of the drawings, or directly or indirectly applied in other relevant technical fields, are similarly included in the scope of patent protection of the invention.

What is claimed is:

1. Walker characterized by, comprising:
first and second support frame;
An expansion rod each disposed at both ends of the first frame and the second frame;
Installation frame, the mounting frame is fixed to one side of the first supporting frame and one side of the second supporting frame, one end of the outer side of the mounting frame is fixed with a rotating frame, and one end of the other mounting frame is connected to the inner side of the rotating frame;
A grip that is fixed to the outer sides of the first support frame and the second support frame.

2. Walker according to claim 1, wherein an end sleeve of the outer side of the expansion rod is provided with a rubber head.

3. Walker according to claim 1, wherein the inner sides of the first and the second supports are fixed with a connecting frame.

4. Walker according to claim 1, wherein a side of the first holder and one side of the second holder are fixed with a number of card interfaces.

5. Walker according to claim 4, wherein one side of the fixing frame is provided with a positioning plate, one side of the positioning plate is fixed with a hook, and the hook card is connected to the inner side of the card interface.

6. Walker according to claim 5, wherein the other side of the positioning plate is fixed with a connecting belt and the outer side sleeve of the connecting strip is provided with a slip sleeve.

7. Walker according to claim 6, wherein the top sleeve is mounted with a sponge pad.
